(19) United States
(12) Patent Application Publication
(10) Pub. No.: US 2013/0312046 A1
(43) Pub. Date: Nov. 21, 2013

(54) SMART STREAM DELIVERY SERVER, SYSTEM AND METHODS FOR ASSEMBLING A MIX OF SERVICES TO BE DELIVERED TO A SUBSCRIBER'S PREMISES

(71) Applicants: Mark Robertson, Lawrenceville, GA (US); Chris Phillips, Hartwell, GA (US)

(72) Inventors: Mark Robertson, Lawrenceville, GA (US); Chris Phillips, Hartwell, GA (US)

(21) Appl. No.: 13/472,051

(22) Filed: May 15, 2012

(51) Int. Cl. H04N 21/266

(52) U.S. Cl. 725/93

(57) ABSTRACT

A smart stream delivery server, a system, and methods are described herein for assembling a mix of services (e.g., linear channels, video on demand, broadcast television, and recordings) which are to be delivered over one or more networks to a premises (e.g., home, business) of a subscriber. In one embodiment, the system includes a smart stream delivery server that assembles the mix of services which are to be delivered over the at least one network to the home of the subscriber based at least on a subscriber policy which is provided by the subscriber. The subscriber policy includes equipment priorities for a list of devices which consume the services, and service priorities for a plurality of services which are available for consumption by the devices.

### TECHNICAL FIELD

The present invention relates to a smart stream delivery server, a system, and methods for assembling a mix of services (e.g., linear channels, video on demand, broadcast television, and recordings) which are to be delivered over one or more networks to a premises (e.g., home, business) of a subscriber.

### BACKGROUND

The following abbreviations are herewith defined, at least some of which are referred to within the following description about at least the prior art and/or the present invention.

### ABR Adaptive Bit Rate

### BCM Bandwidth Consumption Monitor

### CDN Content Delivery Network

### CMS Content Management System

### DSL Digital Subscriber Line

### EPG Electronic Program Guide

### HD High Definition

### HFC Hybrid Fibre-Coaxial

### IGMP Internet Group Management Protocol

### IPTV Internet Protocol Television

### LAN Local Area Network

### LM Logical Multiplex

### MPTS Multi-Program Transport Stream

### SD Standard Definition

### SPTS Single Program Transport Stream

### SIM Service Inventory Manager

### SSDS Smart Stream Delivery Server\

### SSPS Subscriber Service Profile and Policy

### STATMUX Statistical Multiplexer

### STB Set Top Box

### TV Television

### URL Uniform Resource Locator

### VHO Video Head Office

### VOD Video On Demand

### VRGW Virtual Residential Gateway

Currently within the IPTV industry, there are multiple service deployments which exist across a number of network topologies including but not limited to IPTV solutions such as Verizon FiOS and AT&T U-verse as well as deployments of the Ericsson IPTV solution. Regardless of the solution, each service deployment is eventually confronted with a bandwidth constraint such as a DSL link to the subscriber's premises (e.g., home, business) which creates a number of issues for the service provider and ultimately the subscriber who has purchased services from the service provider. Examples of the issues created by the bandwidth constraint include limitations on the quality of the video delivered to the subscriber's premises, limitations on the number of events which can be recorded within the subscriber's premises, limitations on the number of devices which can concurrently receive the services. Furthermore, most if not all of the solutions available today rely on a static set of rules which further restrict the resulting service quality delivered to the subscriber's premises. Because of the bandwidth constraints and the static nature by which the service provider currently implements their IPTV solutions in recognition of the bandwidth constraints, the subscriber has no control of the quality of the services delivered to their premises.

In particular, due to the bandwidth constraint to the subscriber's premises, the service provider typically provides a finite mix of services to the subscriber along with an associated quality which is constrained by a “menu” of services which in effect are static to the subscriber's premises. For instance, the service provider may provide a service (e.g., ESPN) in Standard Definition (SD) or High Definition (HD) but for each, the quality has been pre-determined by the service provider such that if some finite number of devices are used within the subscriber's premises then these devices may view some combined set of services which cannot change or be altered based on consumption. In some cases, based on the current bandwidth consumption, some subscriber requests may also be denied or blocked due to insufficient bandwidth because of the static constraints placed on the available services. Accordingly, there has been and is a need to address these shortcomings and other shortcomings associated with the service provider's static set of rules which in view of the bandwidth constraint even further restricts the resulting service quality delivered to the subscriber's premises. This need and other needs are satisfied by the present invention.

### SUMMARY

A smart stream delivery server, a system, and methods for assembling a mix of services which are to be delivered over one or more networks to a premises of a subscriber are described in the independent claims of the present application. Advantageous embodiments of the smart stream delivery server, the system, and the methods have been described in the dependent claims of the present application.

In one aspect, the present invention provides a smart stream delivery server for assembling a mix of services which are to be delivered over at least one network to a premises of a subscriber. In one example, the smart stream delivery server comprises: a processor, and a memory that stores processor-executable instructions where the processor interfaces with the memory and executes the processor-executable instructions to enable following: (i) receive a request for a particular service from a device associated with the subscriber; (ii) assemble the mix of services which are to be delivered over the at least one network to the premises of the subscriber based on the received request, and on at least one or more parameters, where one parameter is a subscriber policy which is provided by the subscriber; and (iii) transmit the assembled mix of services. The subscriber policy includes equipment priorities for a list of devices associated with the subscriber, and service priorities for a plurality of services which are available for consumption by the devices. An advantage of the smart stream delivery server is that it enables the subscriber to configure their own subscriber policy such that they have at least partial control of the resulting services being delivered to their premises.

In yet another aspect, the present invention provides a system for assembling a mix of services which are to be delivered over at least one network to a premises of a subscriber. In one example, the system comprises a smart stream delivery server, a service inventory manager, a bandwidth consumption monitor, and a subscriber service profile and policy unit. The smart stream delivery server is configured to receive a request for a particular service from a device associated with the subscriber. The service inventory manager is configured to monitor a totality of services including multiple services and their respective bit-rates and formats which can be delivered over the at least one network to the premises of the subscriber. The bandwidth consumption monitor is configured to determine a list of services currently being used or scheduled to be used by the devices. The subscriber service profile and policy unit is configured to store a subscriber policy that is provided by the subscriber and a service provider policy that is provided by a service provider. The smart stream delivery server is further configured to interface with the service inventory manager, the bandwidth consumption monitor, and the subscriber service profile and policy unit to assemble a mix of services which are to be delivered over the at least one network to the premises of the subscriber based on the received request and following parameters: (i) the subscriber policy which is provided by the subscriber and comprises: equipment priorities for a list of devices associated with the subscriber; and service priorities for a plurality of services which are available for consumption by the devices; (ii) the totality of services including multiple services and their respective bit-rates and formats which can be delivered over the at least one network to the premises of the subscriber; (iii) the list of services currently being used or scheduled to be used by the devices; and (iv) the service provider policy which prioritizes at least one of a quality and a quantity of the services to be delivered to the premises; and (v) the smart stream delivery server is further configured to transmit the assembled mix of services. An advantage of the system is that it enables the subscriber to configure their own subscriber policy such that they have at least partial control of the resulting services being delivered to their premises.

In still yet another aspect, the present invention provides a method implemented by a smart stream delivery server for assembling a mix of services which are to be delivered over at least one network to a premises of a subscriber. In one example, the method comprises the steps of: (a) receiving a request for a particular service from a device associated with the subscriber; (b) assembling the mix of services which are to be delivered over the at least one network to the premises of the subscriber based on the received request and on at least one or more parameters, where one parameter is a subscriber policy which is provided by the subscriber; and (c) transmitting the assembled mix of services. The subscriber policy includes equipment priorities for a list of devices associated with the subscriber, and service priorities for a plurality of services which are available for consumption by the devices. An advantage of the method is that it enables the subscriber to configure their own subscriber policy such that they have at least partial control of the resulting services being delivered to their premises.

In still yet another aspect, the present invention provides a method for assembling a mix of services which are to be delivered over at least one network to a premises of a subscriber. In one example, the method comprises the steps of: (a) receiving, at a smart stream delivery server, a request for a particular service from a device associated with the subscriber; (b) monitoring, at a service inventory manager, a totality of services including multiple services and their respective bit-rates and formats which can be delivered over the at least one network to the premises of the subscriber; (c) determining, at a bandwidth consumption monitor, a list of services currently being used or scheduled to be used by the devices; (d) storing, at profile and policy unit, a subscriber policy that is provided by the subscriber and a service provider policy that is provided by a service provider; (e) assembling, at the smart stream delivery server, the mix of services which are to be delivered over the at least one network to the premises of the subscriber based on the received request and on following parameters: (i) the subscriber policy which is provided by the subscriber and includes equipment priorities for a list of devices which consume the services, and service priorities for a plurality of services which are available for consumption by the devices; (ii) the totality of services including multiple services and their respective bit-rates and formats which can be delivered over the at least one network to the premises of the subscriber; (iii) the list of services currently being used or scheduled to be used by the devices; and (iv) the service provider policy which prioritizes at least one of a quality and a quantity of the services to be delivered to the premises; and (f) transmitting, from the smart stream delivery server, the assembled mix of services. An advantage of the method is that it enables the subscriber to configure their own subscriber policy such that they have at least partial control of the resulting services being delivered to their premises.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIG. 1 is a diagram of a system including an exemplary smart stream delivery server configured to assemble a mix of services which are to be delivered over one or more networks to a premises of a subscriber in accordance with an embodiment of the present invention;

FIG. 2 is a flowchart illustrating the steps of an exemplary method implemented by a smart stream delivery server for assembling a mix of services which are to be delivered over one or more networks to a premises of a subscriber in accordance with an embodiment of the present invention;

FIGS. 3A-3B is an illustration of the system shown in FIG. 1 incorporated within a IPTV deployment configuration which utilizes broadcast services to physically multiplex the broadcast services to the subscriber's premises in accordance with an embodiment of the present invention;

FIGS. 4A-4B is an illustration of the system shown in FIG. 1 incorporated within a IPTV deployment configuration which utilizes broadcast services and adaptive streaming technology to physically multiplex the broadcast services to the subscriber's premises in accordance with an embodiment of the present invention;

FIGS. 5A-5B is an illustration of the system shown in FIG. 1 incorporated within a IPTV deployment configuration which utilizes broadcast services and a virtual residential gateway to physically multiplex the broadcast services to the subscriber's premises in accordance with an embodiment of the present invention; and

FIGS. 6A-6B is an illustration of the system shown in FIG. 1 incorporated within a IPTV deployment configuration which utilizes broadcast services to logically multiplex broadcast services and video on demand services to the subscriber's premises in accordance with an embodiment of the present invention.

### DETAILED DESCRIPTION

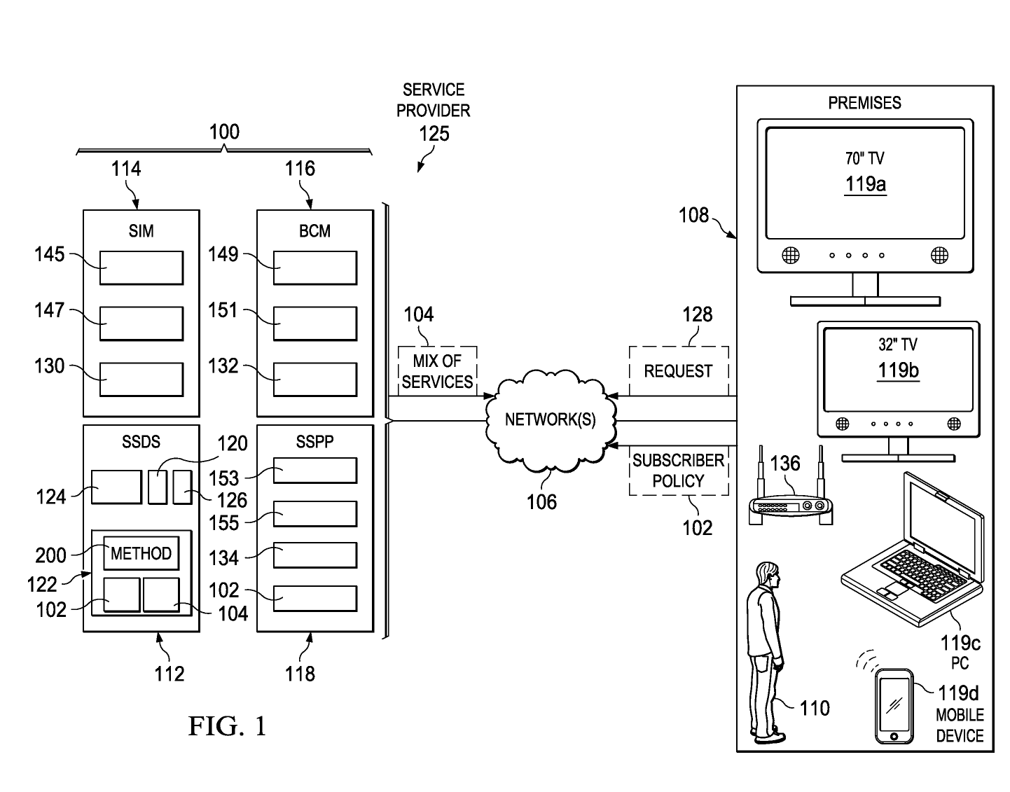

Referring to FIG. 1, there is a diagram of an exemplary system 100 which is configured to take into account at least a subscriber policy 102 to assemble a mix of services 104 (e.g., linear broadcast channels, video on demand, recordings gaming sessions, pay per view) which are to be delivered over at least one network 106 to a premises 108 (e.g., home, business) of a subscriber 110 in accordance with an embodiment of the present invention. The exemplary system 100 includes a smart stream delivery server 112 (SSDS), a service inventory manager 114 (SIM), a bandwidth consumption monitor 116 (BCM), and a subscriber service profile and policy unit 118 (SSPP). These components 112, 114, 116 and 118 can be separate hardware devices located in one facility (e.g., the customer local operations office) or distributed throughout multiple facilities. Alternatively, these components 112, 114, 116, and 118 can be co-located in one hardware device. In any case, one skilled in the art having access to the teachings herein will readily understand that there are many different configurations which can be used to enable the smart stream delivery server 112 to interact with at least one of the service inventory manager 114, the bandwidth consumption monitor 116, the subscriber service profile and policy unit 118 and possibly other components which are well known in the art such as an EPG server, CDN server, statmux etc. . . . to take into account the subscriber policy 102 and possibly other parameters when assembling the mix of services 104 which are to be delivered to the subscriber's premises 108 and then consumed by one or more subscriber devices 119a, 119b, 119c, and 119d.

The smart stream delivery server 112 includes an input interface 120, processor 122, a memory 124, and an output interface 126. The processor 122 interfaces with the memory 124 which stores processor-executable instructions to execute those processor-executable instructions to enable the input interface 120 to receive a request 128 (e.g., channel change request 128) for a particular service from one of the devices 119a (for example) associated with the subscriber 110. In this case, assume the subscriber 110 has multiple devices 119a, 119b, 119c and 119d located within their premises 108. For instance, the subscriber 110 may have a HD television 119a, a SD television 119b, a personal computer 119c, and a mobile device 119d located within their premises 108. Then, anyone or combination of the devices 119a, 119b, 119c and 119d could be receiving and consuming one or more different services 104 at any given time and could have one or more services 104 scheduled for consumption in the future.

The processor 120 also executes the processor-executable instructions to assemble the mix of services 104 which are to be delivered over the at least one network 106 to the subscriber's premises 108 based on the received request 128 and at least the subscriber policy 102. For example, the subscriber policy 102 includes at least: (1) equipment priorities for the list of devices 119a, 119b, 119c and 119d; and (2) service priorities for a plurality of services 104 which are available for consumption by the devices 119a, 119b, 119c and 119d. In this example, the subscriber service profile and policy unit 118 would receive the subscriber policy 102 from the subscriber 110, store the subscriber policy 102, and when requested would forward or could automatically forward the subscriber policy 102 to the smart stream delivery server 112. Alternatively, the smart stream delivery server 112 could receive the subscriber policy 102, store the subscriber policy 102 and utilize the subscriber policy 102 after receiving the request 128. In addition, the processor 120 may also when assembling the mix of services 104 take into account the bandwidth constraints imposed by the at least one network 106 used to deliver the mix of services 104 to the subscriber's premises 108.

The processor 120 may also assemble the mix of services 104 while taking into account one or more parameters in addition to the subscriber policy 102. For instance, the processor 120 may assemble the mix of services 104 based on a totality of services 130 and their respective bit-rates and formats which could be delivered over the at least one network 106 to the subscriber's premises 108. In this example, the service inventory manager 114 would determine the totality of services 130 and their respective bit-rates and formats which can be delivered over the at least one network 106 to the subscriber's premises 108. Then, the service inventory manager 114 when requested would forward or could automatically forward this particular information to the smart stream delivery server 112. Alternatively, the smart stream delivery server 112 could by itself determine and store therein the totality of services 130 and their respective bit-rates and formats which could be delivered over the at least one network 106 to the subscriber's premises 108.

The processor 120 may assemble the mix of services 104 while taking into yet another parameter which is a list 132 of services that are currently being used or schedule to be used by the devices 119a, 119b, 119c and 119d. In this example, the bandwidth consumption monitor 116 would monitor and create the list 132 of services that are currently being used or schedule to be used by the devices 119a, 119b, 119c and 119d. Then, the bandwidth consumption monitor 116 when requested would forward or could automatically forward this particular information to the smart stream delivery server 112. Alternatively, the smart stream delivery server 112 could by itself monitor and create the list 132 of services that are currently being used or schedule to be used by the devices 119a, 119b, 119c and 119d.

The processor 120 may assemble the mix of services 104 while taking into account still yet another parameter which is a service provider policy 134 that is provided by the service provider 125. In this example, the subscriber service profile and policy unit 118 would receive the service provider policy 134 from the service provider 125, store the service provider policy 134, and when requested forward or automatically forward the service provider policy 134 to the smart stream delivery server 112. Alternatively, the smart stream delivery server 112 could receive the service provider policy 134, store the service provider policy 134 and utilize the service provider policy 134 after receiving the request 128. For example, the service provider policy 134 prioritizes at least one of a quality and a quantity of the services to be delivered to the premises 108. The service provider policy 134 if used would take precedence over the subscriber policy 102.

Finally, the processor 120 also executes the processor-executable instructions to transmit from the output interface 126 the assembled mix of services 104 which are to be delivered over the at least one network 106 to the subscriber's premises 108 based on the received request 128 and at least the subscriber policy 102. A more detailed discussion is provided below about the smart stream delivery server 112, the service inventory manager 114, the bandwidth consumption monitor 116, and the subscriber service profile and policy unit 118.

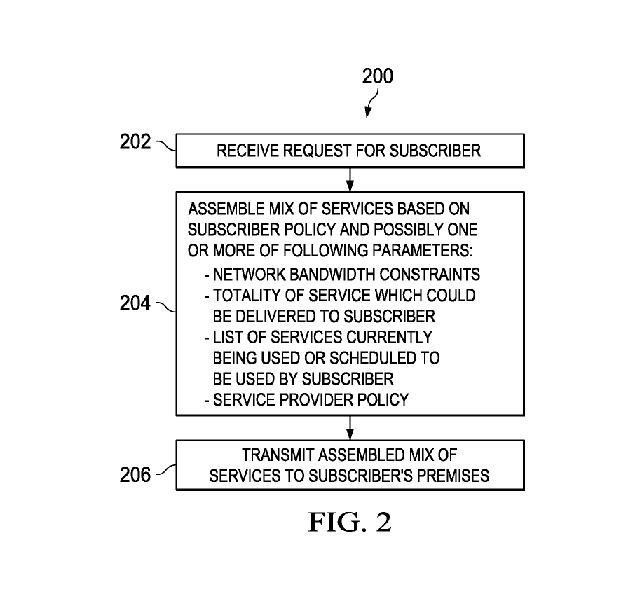

Referring to FIG. 2, there is a flowchart illustrating the steps of an exemplary method 200 implemented by the smart stream delivery server 112 for assembling the mix of services 104 which are to be delivered over one or more networks 106 to the subscriber's premises 108 in accordance with an embodiment of the present invention. At step 202, the smart stream delivery server 112 receives the request 128 for a particular service from one of the devices 119a, 119b, 119c, 119d associated with the subscriber 110. At step 204, the smart stream delivery server 112 assembles the mix of services 104 which are to be delivered over the at least one network 106 to the subscriber's premises 108 based on the received request 128 and on at least one or more parameters, where one parameter is the subscriber policy 102. As described above, the subscriber policy 102 which is previously provided by the subscriber 110 can include at least: (1) equipment priorities for the list of devices 119a, 119b, 119c and 119d; and (2) service priorities for a plurality of services 104 which are available for consumption by the devices 119a, 119b, 119c and 119d. If desired, the smart stream delivery server 112 can also assemble the mix of services 104 based on one or more of the following parameters: (1) bandwidth constraints imposed by the at least one network 106 used to deliver the mix of services 104 to the subscriber's premises 108; (2) the totality of services 130 and their respective bit-rates and formats which could be delivered over the at least one network 106 to the subscriber's premises 108; (3) the list 132 of services that are currently being used or schedule to be used by the devices 119a, 119b, 119c and 119d; and (4) the service provider policy 134. At step 206, the smart stream delivery server 112 transmits the assembled mix of services 104 which are to be delivered over the at least one network 106 to the subscriber's premises 108. The assembled mix of services 104 can be a logical mix of services which is shared with one or more nodes in the one or more networks 106 which then deliver the physical services to the subscriber's premises 108. Alternatively, the assembled mix of services 104 can be a physical mix of services themselves which are delivered over the one or more networks 106 to the subscriber's premises 108.

The system 100 and method 200 described above may utilize the aforementioned components 112, 114, 116 and 118 to assemble the mix of services 104 but it should be understood that the system 100 and method 220 can also utilize well known components such as an EPG server, a CDN server, a statmux etc. . . . to implement the various features associated with different embodiments the present invention. The discussion provided below describes in greater detail some of these various features associated with the different embodiments of the present invention. In addition, the discussion provided below describes several different exemplary IPTV deployment configurations in which the system 100 and method 200 can be implemented in accordance with different embodiments of the present invention.

The system 100 and method 200 enables the subscriber 110 which subscribes to receive services provided by the service provider 125 to create and manage their own subscriber policy 102 which controls how the service provider 125 assembles the mix of services 104 which will be delivered to the subscriber's premises 108. If desired, the service provider 125 can also take into account their own service provider policy 134 along with the subscriber policy 102 to prioritize at least one of the quality and the quantity of the services 104 to be delivered to the subscriber's premises 108 and remain within the bandwidth constraints imposed by the delivery network 106 that is deployed by the service provider 125.

The service provider's smart stream delivery server 112 can be configured to use the subscriber policy 102, the service provider policy 134 (if used) and if desired some additional information which is available to assemble a physical or logical mix of services 104 to be delivered and consumed in the subscriber's premises 108. For instance, the smart stream delivery server 112 may acquire additional information from the service provider 125 about the network topology which may place further constraints on the mix of services 104 to be delivered to the subscriber 110 including for example services currently in use in the subscriber's premises 108 and the services currently scheduled to be used in the future in the subscriber's premises 108. In addition, the smart stream delivery server 112 may acquire information about the bandwidth constraints between various nodes or layers in the delivery network 106 which themselves may constrain the mix of services 104 to be delivered to the subscriber's premises 108. The smart stream delivery server 112 may also acquire additional information from the service inventory manager 114 which identifies the totality of services 130 and their respective bit-rates, formats which could be delivered to the subscriber's premises 108.

The smart stream delivery server 112 in assembling the mix of services 104 can be first controlled by the subscriber policy 102 which can comprises priority assignments that are made to a service, a device, or a user within the subscriber's premises 108. Examples of priorities include equipment priorities where the subscriber 110 is presented with an enumerated list of equipment which falls within the list of “managed” devices 118 within their premises 108 such as each STB (or associated TV), PC, tablet or other devices which will be used within the premises 108 to consume services over the service provider's delivery network 106. In addition, the subscriber 110 may prioritize each service available for their consumption including the linear-broadcast channels available within their subscription channel line-up. Lastly, the subscriber 110 can prioritize their services based on the higher level services such as for example Video On Demand (VOD), Broadcast TV, and recordings.

The overall control provided by the smart stream delivery server 112 in assembling the mix of services 104 can be enhanced by consulting the services which are available to be provided to the subscriber's premises 108 including for example the totality of broadcast services including their bit-rates and formats. The same information if available for VOD services can be applied and used as well in controlling the asset selection when the subscriber 110 initiates a VOD session set-up. As additional services are made available, the characteristics of those services which are identified by the available policies 102 and 134 can be introduced and accounted for to help control the total bandwidth used within the service provider's network 106 and the subscriber's premises 108. The smart stream delivery server 112 can also utilize knowledge about all of the services currently consumed within the subscriber's premises 108 or scheduled for future consumption in the subscriber's premises 108. Knowing this information, the smart stream delivery server 112 can upon receiving each request 128 from the subscriber's premises 108 function to alter the mix of services 104 based on the subscriber policy 102 (and possibly the service provider policy 134) such that the services 104 match the subscriber policy 102 (and possibly the service provider policy 134) as configured by the subscriber 104 (and possibly by the service provider 125). The desired mix of services 104 whether logical or physical can be shared between nodes of the network(s) 106 as needed such that the resulting physical services are delivered to the subscriber's premises 108 as defined by their bandwidth and service subscriber policy 102.

For example, within the service provider's control office, the smart stream delivery server 112 could be used to create a unicast mix of services 104 to be delivered to the subscriber's premises 108. In particular, the smart stream delivery server 112 assembles the unicast mix of services 104 which is composed of the optimal set of services selected from the totality of services available within the central office to be delivered to the subscriber's premises 108. The unicast mix of services 104 may be altered at any point due to anyone of a number of factors which impact the bandwidth consumption in the subscriber's premises 108. Example events which would impact the unicast mix of services 104 would include a piece of equipment 118 tuning to a particular service (e.g., ESPN). Then, depending on the existing bandwidth consumed by the unicast mix of services 104, the smart stream delivery server 112 may alter the mix of services 104 based on the subscriber policy 102 defined by the subscriber 110 to maximize the number of streams available to the subscriber's premises 108.

In addition, the smart stream delivery server 112 allows for services to be controlled or simply monitored. In particular, the smart stream delivery server 112 can control some services within the mix of services 104 based at least on the subscriber policy 102 and may only monitor some services within the mix of services 104 which are consumers of bandwidth but cannot be altered in the mix of services 104 in real-time because of changes occurring in the subscriber's premises 108 or within the delivery network(s) 106. An example of this type of “unalterable” service might include the VOD service. The smart stream delivery server 112 may select the unalterable VOD service based on information available at the time but once initiated the unalterable VOD service may not be altered over time. In this case, the unalterable VOD asset which fits within the current bandwidth at the time the request 128 is processed cannot later be altered hence the VOD asset consumes a fixed amount of bandwidth over time. Alternatively, if supported by the VOD solution, the smart stream delivery server 112 may affect an alterable VOD asset being delivered such that the subscriber policy 102 may be used to address the priorities and resultant quality of the delivered mix of services 104. For example, if the alterable VOD service is being delivered utilizing adaptive bit-rate technologies, then the smart stream delivery server 112 may instruct the adaptive infrastructure to lower or raise the delivered bit-rate of the VOD service to the subscriber's premises 108 as needed using adaptive technologies. The net effect of manipulating the service and bandwidth consumption results in creating an additional capacity within the mix of services 104 to be delivered to the subscriber's premises 108 such that the associated quality of the any one service can be increased etc.

The service provider's customer office may be located nationally, regionally or locally, and the smart stream delivery server 112 may be located in this office and deliver the mix of services 104 to a gateway device 136 located within the subscriber's premises 108. The gateway device 136 is the termination point of the network delivery from the respective central office. For example, within an IPTV deployment the gateway device 136 which is located within the subscriber's premises 108 would be a device known as a residential gateway 136. The residential gateway 136 would have the responsibility to receive the mix of services 104, disassemble and perform various protocol conversions on the mix of services 104 as required so they can be consumed by the subscriber's devices 119a, 119b, 119c and 119d. For instance, the residential gateway 136 could remove a broadcast service from the mix of services 104 and multicast the service for cases where the device 119a, 119b, 119c or 119d (or STB) within the subscriber's premises 108 expects the service to be available as a multicast stream.

The smart stream delivery server 112 and the concepts of the policy control described above are independent on how the mix of services 104 might be delivered to the subscriber's premises 108. For example, the totality of bandwidth to the subscriber's premises 108 may be transported using any technology including Fiber, HFC, Copper. Furthermore, the previous example described above explained the concept of the smart stream delivery server 112 assembling the mix of services 104 in the service provider's control office and unicasting the mix of service 104 to the residential gateway 136 in the subscriber's premises 108. Then, the residential gateway 136 taking responsibility for the protocol conversion (e.g., unicast MPTS to multicast SPTS) so the mix of services 104 can be consumed by the devices 119a, 119b, 119c and 119d. However, the smart stream delivery server 112 may accomplish this policy implementation in other fashions using for instance adaptive technology to enable virtual or actual manifest manipulation of the bit rates of the services.

To illustrate some of the exemplary features of the present invention, assume the subscriber 110 (user A) has a TV 119a (70″ 3D HDTV 119a) and associated STB and tunes (IGMP join) to the ESPN service (a sports channel) within the premises 108. The request 128 for the ESPN service is sent to the central office and directed to the smart stream delivery server 112. The smart stream delivery server 112 first determines there are no existing streams delivered to the premises and no recordings scheduled by consulting the bandwidth consumption monitor 116. Then, the smart stream delivery server 112 selects the highest quality service available for the ESPN service by consulting the service inventory manager 114 to determine the different EPSN services that can fit in the available bandwidth to the subscriber's premises 108. For exemplary purposes, assume there is a total bandwidth to the premises 108 of 10 Mbs, the smart stream delivery server 112 selects the ESPN service at 10 Mbs and sends the associated service 104 to the premises 108. The residential gateway 136 de-multiplexes the service 104 and multicasts the 10 Mbs ESPN service on the required multicast address for decoding by the STB and display on the TV 119a.

Then, within the same premises 108, assume the subscriber 110 (user B) starts using a second TV 119b (32″ SDTV 119b) and associated STB and tunes (IGMP join) to the HBO service (a cable channel) within the premises 108. The request 128 for the HBO service is sent to the central office and directed to the smart stream delivery server 112. The smart stream delivery server 112 consults the bandwidth consumption server 116 and determines there is currently a 10 Mbs bandwidth limitation to the premises 108, there is an existing stream (e.g., ESPN) being delivered to the premises 108 at 10 Mbs, and that there are no recordings scheduled for future use at the subscriber's premises 108. Then, the smart stream delivery server 112 consults the service inventory manager 114 and the subscriber profile 102 and selects the highest quality service available for HBO which can fit in the available bandwidth to the subscriber's premises 108. For exemplary purposes, assume there is a total bandwidth to the premises 108 of 10 Mbs, the smart stream delivery server 112 selects the ESPN service at 5 Mbs and the HBO service at 5 Mbs and sends the mix of services 104 to the subscriber's premises 108. The ESPN service delivered to TV 119a has now been lowered to 5 Mbs (based on the subscriber policy 102) and the HBO service is provided at 5 Mbs (based on subscriber policy 102) to TV 119b. The residential gateway 136 performs the same unicast to multicast conversion for the HBO service as it does for the ESPN service. In this example, the subscriber policy 102 was what controlled the fact that the ESPN service delivered to TV 119a could be lowered to accommodate the HBO service. In the same sense, the 5 Mbs HBO service, although available at 10 Mbs, was selected based on available bandwidth and the policy controls. Basically, the subscriber policy 102 and possibly the service provider policy 134 indicate the priority of how services may be arranged and re-ordered for consumption by TVs 119a and 119b.

The following is a discussion about several different exemplary IPTV deployment configuration in which the system 100 and method 200 can be implemented in accordance with different embodiments of the present invention. In the following discussion, it should be appreciated that any one of the respective components described below may be located and executed within the service provider's network or any portion of another network under the control of the service provider 125.

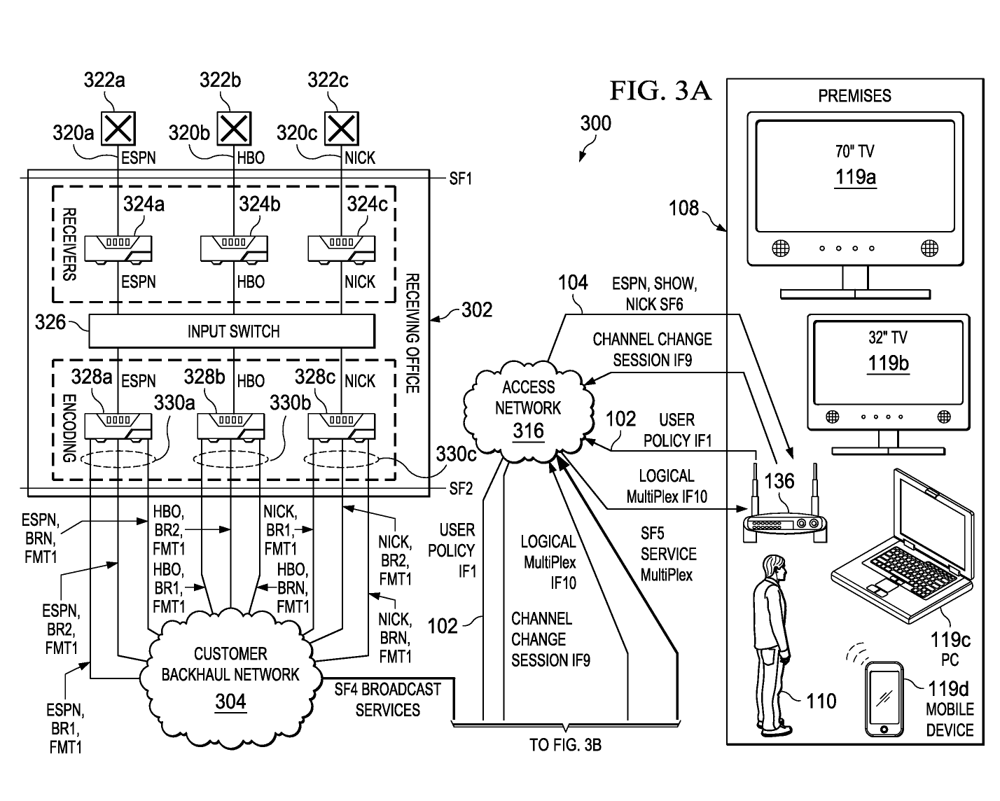

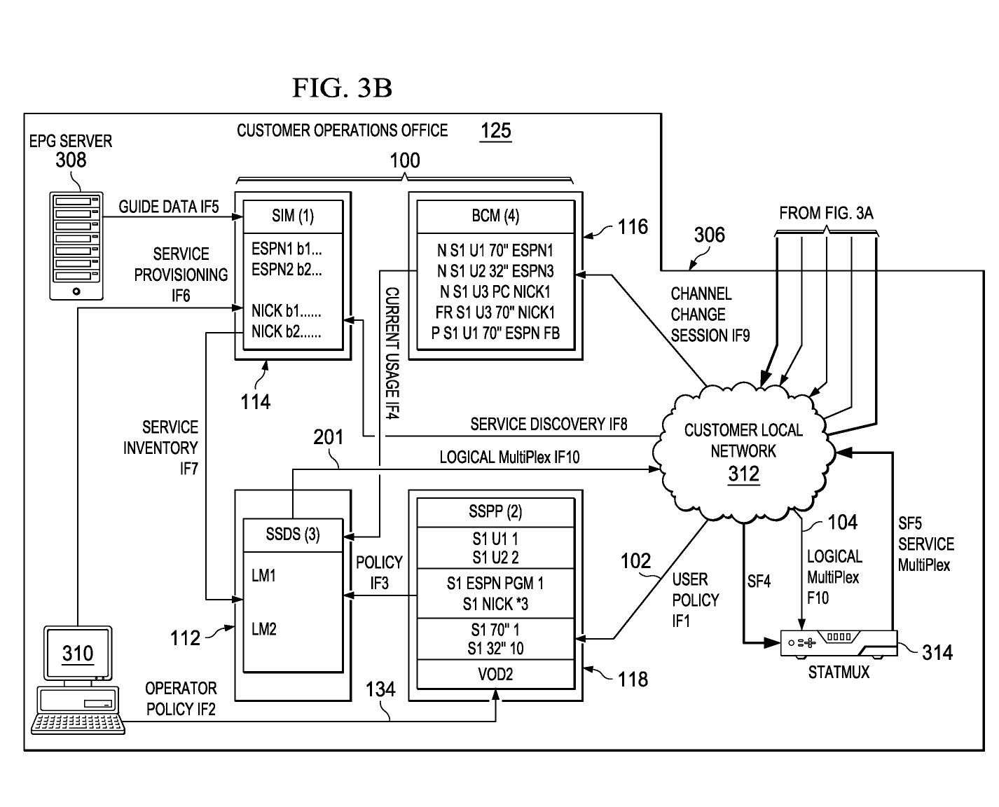

Referring to FIGS. 3A-3B, there is an illustration of an exemplary system 100 incorporated within a IPTV deployment configuration 300 which utilizes broadcast services to physically multiplex the broadcast services to the subscriber's premises 108 in accordance with an embodiment of the present invention. The IPTV deployment configuration 300 is from the point of content or service reception within a service provider's receiving office 302 to the delivery of the services 104 to the subscriber's premises 108. In this example, the IPTV deployment configuration 300 includes the receiving office 302 which is connected by a customer backhaul network 304 to a central office 306. The central office 306 incorporates the system 100 which comprises the smart stream delivery server 112, the service inventory manager 114, the bandwidth consumption monitor 116, and the subscriber service profile and policy unit 118. In addition, the central office 306 incorporates an EPG server 308, a service provider's computer 310, a customer local network 312, and a statmux 314. As shown, the system 100 interfaces with the EPG server 308, the service provider's computer 310, and the customer local network 312. The customer local network 312 interfaces with the customer backhaul network 304 and the statmux 314. In addition, the customer local network 312 interfaces with an access network 316 which interfaces with the residential gateway 136 located in the subscriber's premises 108. The residential gateway 136 is connected to the subscriber's devices 119a, 119b, 119c and 119d. The IPTV deployment configuration 300 could include many other well known components but for clarity those components are not described herein.

The following service flow description and interface description describe the various steps used so the service provider 125 can provide the mix of services 104 to the residential gateway 136 at the subscriber's premises 108 in accordance with an exemplary embodiment of the present invention.

### Service Flow Description:

SF1: Broadcast Services 320a, 320b and 320c are received via satellite dish(es), a dedicated network and/or antennas 322a, 322b and 322c and enters receivers 324a, 324b and 324c. In this example, the broadcast services 320a, 320b and 320c include the well known programs ESPN 320a, HBO 320b, and Nickelodeon 320c but would generally include many more services. The receivers 324a, 324b and 324c are connected to an input switch 326 which is connected to encoders 328a, 328b and 328c.
SF2: The encoders 328a, 328b and 328c are set up to encode each broadcast service 320a, 320b and 320 with multiple bitrates (BR1, BR2 . . . BRN) and formats (FMT1). The resulting encoded streams 330a, 330b and 330c are multicast over the customer backhaul network 304.
Note: SF1 and SF2 could be positioned at various points in the network. An example usage of having local positioning would be the local station affiliate.
SF4—The encoded streams 330a, 330b and 330c are routed onto the customer local network 312 and is fed into the statmux 314.
SF5—The service multiplex 104 (physical content) from the statmux 314 is sent via multicast or unicast back over the customer local network 312 and onto the access network 316.
SF6—Depending on the union of the subscriber's policy 102 and the service provider policy 134 stored in the subscriber service profile and policy unit 118, the smart stream delivery server 112 determines and ensures the correct stream of services 104 (see logical multiplex IF 10) based on the user/device/etc will be selected by the statmux 314 and presented for viewing or consumption by the respective devices 119a, 119b, 119c and 119d. Note: one subscriber 110 is shown and described herein but there would by many subscribers 110 which can utilize the present invention.

### Interface Description:

IF1: The user policy interface IF1 allows the subscriber 110 to set up their own policy 102 for managing their streaming bandwidth to their devices 119a, 119b, 119c and 119d. This policy 102 can be based on user, device, service, etc. For example, the subscriber 110 could log into the service provider's web portal to input and define their policy 102. As can be seen, the user policy interface IF1 traverses the access network 316 to the customer local network 312 so the subscriber policy 102 can be stored in the subscriber service profile and policy unit 118.
IF2: The service provider policy 134 is supplied by the service provider's computer 310 to the subscriber service profile and policy unit 118 by the IF2 interface. In case of a conflict of policies 102 and 134, the service provider policy 134 may override the subscriber policy 102 (actually all of subscriber policies 102). The service provider 125 could supply policies such as tiered subscription policies for a premium Quality of Service subscription, higher bit rate for premium content QoS, etc.
IF3: The union of the policy definitions from the subscriber policy 102 and the service provider policy 134 is delivered to the smart stream delivery server 112 which is one of the parameters used in the determination of the decisions made to assemble the mix of the services 104 to be delivered to the subscriber's premises 108.
IF4: The bandwidth consumption monitor 116 provides the current as well as the planned bandwidth usage, based on scheduled recordings, to the smart stream delivery server 112. The smart stream delivery server 112 can use the policies 102 and 134 along with bandwidth usage to determine which streams get delivered to the subscriber's premises 108.
IF5: The EPG server 308 provides programming information based on the operators broadcast channel lineup to the service inventory manager 114.
IF6: The service provider's computer 310 provides programming information along with stream definitions such as stream format information and bit rate information which are based on the streams generated by the encoders 328a, 328b and 328c shown at SF2 to the service inventory manager 114.
IF7: The service inventory manager 114 provides service inventory to the smart stream delivery server 112. The service inventory contains information about all of the channels provided by the service provider as well as their encoding definitions which allows the smart stream delivery server 112 to create the logical multiplex of services 104.
IF8: The service discovery interface IF8 allows the service inventory manager 114 to discover services without requiring the service provider 125 to manually enter the information and then send to the service inventory manager 114.
IF9: The channel change session interface IF9 connects the residential gateway 136 to the bandwidth consumption monitor 116. This allows the bandwidth consumption monitor 116 to accurately have knowledge about each service being delivered to each device 119a, 119b, 119c and 119d in the subscriber's premises 108.
IF10: The smart stream delivery server 112 creates the logical multiplex of services 104 which defines all services to all devices 119a, 119b, 119c and 119d in the premises 108 based on the subscriber policy 102, the service provider policy 134 as well as the operator service provisioning. The logical multiplex of services 104 extends into the residential gateway 136 and allows the residential gateway 136 to provide the correct set of services to the devices 119a, 119b, 119c and 119d based on the definition calculated by the smart stream delivery server 112. The logical multiplex of services 104 also interfaces with the statmux 314 which defines the physical services-streams to be sent to the devices 119a, 119b, 119c and 119d based on the calculated services in the smart stream delivery server 112.

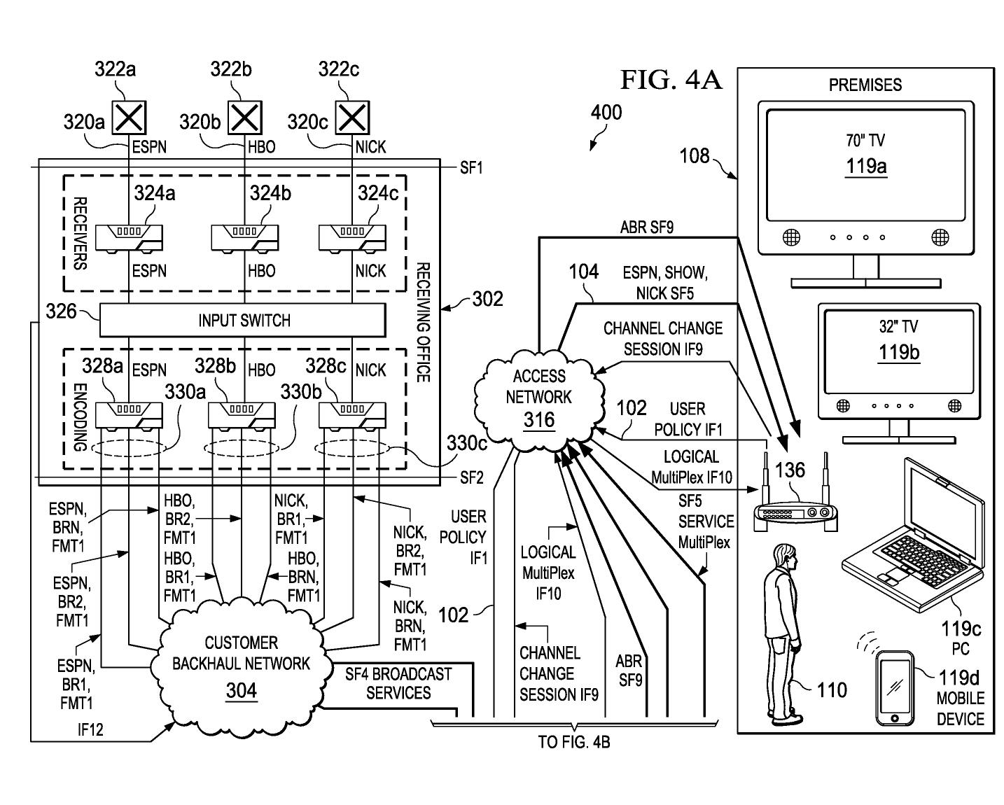

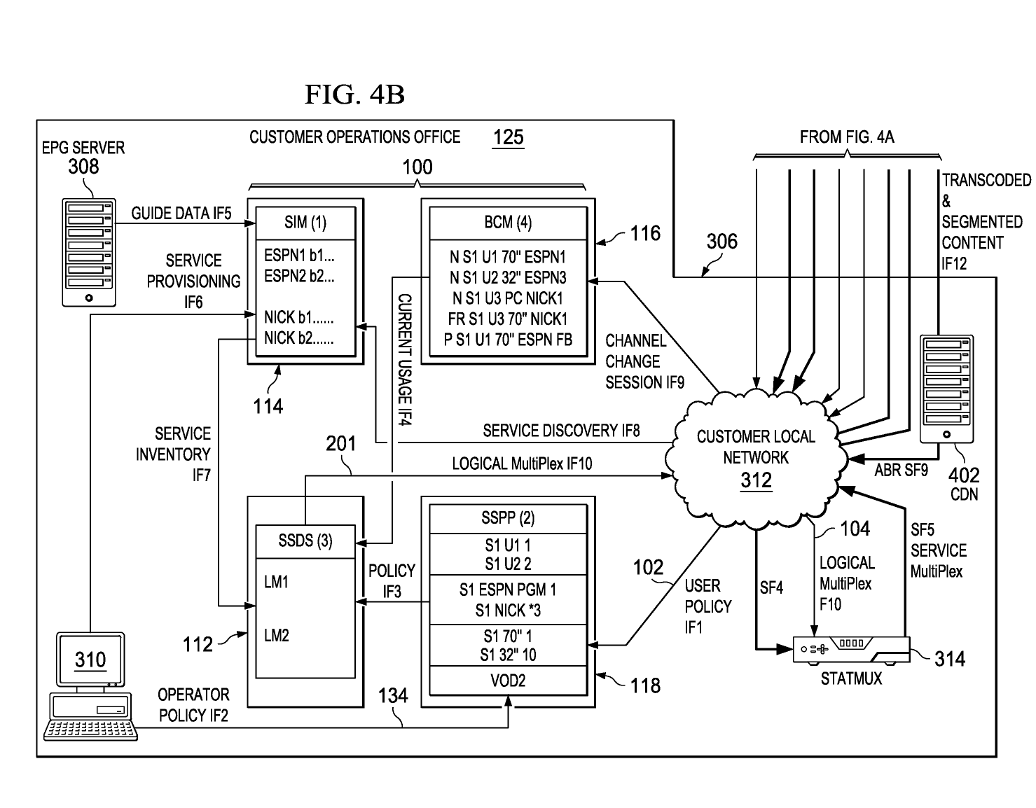

Referring to FIGS. 4A-4B, there is an illustration of an exemplary system 100 incorporated within a IPTV deployment configuration 400 which utilizes broadcast services and adaptive streaming technology to physically multiplex the broadcast services to the subscriber's premises 108 in accordance with an embodiment of the present invention. The IPTV deployment configuration 400 is the same as the aforementioned IPTV deployment configuration 300 except that the central office 306 incorporates a CDN 402 which is coupled to the customer backhaul network 304 and the customer local network 312. In this case, the adaptive bitrate streaming technology could be involved with delivering different encoded streams to consumer electronics devices such as a Home LAN connected tablet device, mobile phone 119d, gaming console, Blu-Ray Player, Connected TV, etc.

The aforementioned service flows SF1, SF2, SF4, SF5 and SF6 and interfaces IF1, IF2, IF3, IF4, IF5, IF6, IF7, IF8, IF9 and IF10 apply in this particular IPTV deployment configuration 400 as well along with the addition of the adaptive bitrate streaming functionality. However, the use of the adaptive bitrate streaming functionality requires the addition of SF 9 and IF 12 which are as follows:

SF9: When an adaptive bitrate device 119b (or any of the other aforementioned consumer electronic devices which have adaptive bitrate technology) requests a channel over the unmanaged network, the request 128 will typically be made to the CDN 402. The CDN 402 will contain the manifest representations of the broadcast channels as well as groups of segmented files. The groups of segmented files will be encoded at bitrates that range from low bitrate to high bitrate encodings. These groups of encoded segmented files are represented by manifest files which contain location URLs defined for each group of the encoded bitrates. In broadcast environments, the manifests are updated at timeframes depending on the defined segment sizes. The adaptive bitrate device 119d updates its manifest as needed again depending on the defined segment sizes.
IF12: The adaptive streaming manifest as well as adaptive bitrate encoded/transcoded segments are delivered by the encoders 328a, 328b and 328c into the customer backhaul network 304 and cached in the CDN 402.

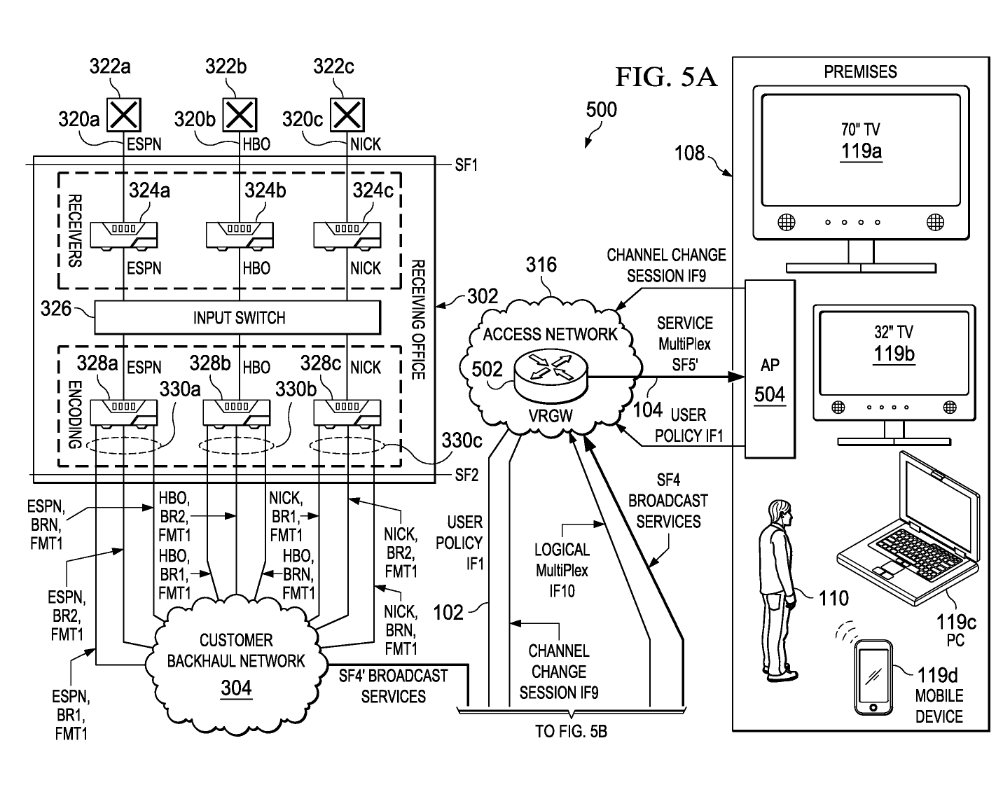

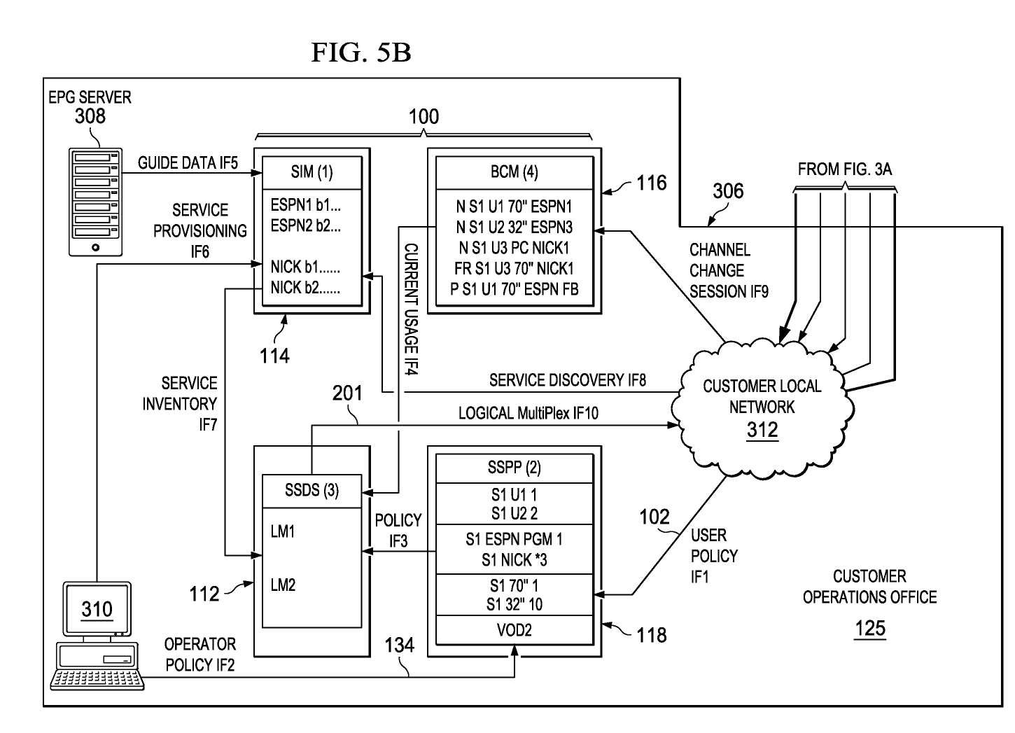

Referring to FIGS. 5A-5B, there is an illustration of an exemplary system 100 incorporated within a IPTV deployment configuration 500 which utilizes broadcast services and a virtual residential gateway 502 to physically multiplex the broadcast services to the subscriber's premises 108 in accordance with an embodiment of the present invention. The IPTV deployment configuration 500 is the same as the aforementioned IPTV deployment configuration 300 except that the access network 316 includes the virtual residential gateway 502 and the subscriber's premises 108 includes an access point 504 rather than the residential gateway 136. The virtual residential gateway 502 is a relatively new gateway concept aimed at moving the complexity of the operator's bandwidth policies, routing functionality, firewall rules, etc from the subscriber's premises 108 back into the edge of the operator's access network 316. With the addition of the virtual residential gateway 502, the statmux functionality can be moved into the hardware associated with the virtual residential gateway 502 rather than utilizing a statmux 314 in the central office 306 (compare FIGS. 3 and 5). The virtual residential gateway 502 resides at the edge of the access network 316 and can be co-located with a digital subscriber line broadband router. In fact, the latest generation high performance digital subscriber line broadcast routers can support running services such as the virtual residential gateway 502 inside the router itself. Plus, the latest generation high performance digital subscriber line broadcast routers can have the processing capabilities to actually embed the statmux functionality inside the virtual residential gateway 502.

In any case, the aforementioned service flows SF1 and SF2 and IF1, IF2, IF3, IF4, IF5, IF6, IF7, IF8, IF9, and IF10 shown in FIG. 3 apply as well to the IPTV deployment configuration 500. However, in the IPTV deployment configuration 500 there is no IF10 between the subscriber's premises 108 and the access network 316 and the aforementioned SF4 and SF5 shown in FIG. 3 would be revised as follows:

SF4′: The broadcast services are routed onto the customer local network 312 which is fed into the virtual residential gateway 502. The statmux functionality (formerly the physical statmux 316) has been moved into virtual residential gateway 502 which is at the edge of the access network 316.
SF5′: The service multiplex of physical services 104 from the statmux functionality in the virtual residential gateway 502 is sent via multicast or unicast directly to the access point 504 located inside the subscriber's premises 108.

Note: If desired the adaptive streaming functionality and CDN 402 described above in the IPTV deployment configuration 400 could also be incorporated within the IPTV deployment configuration 500.

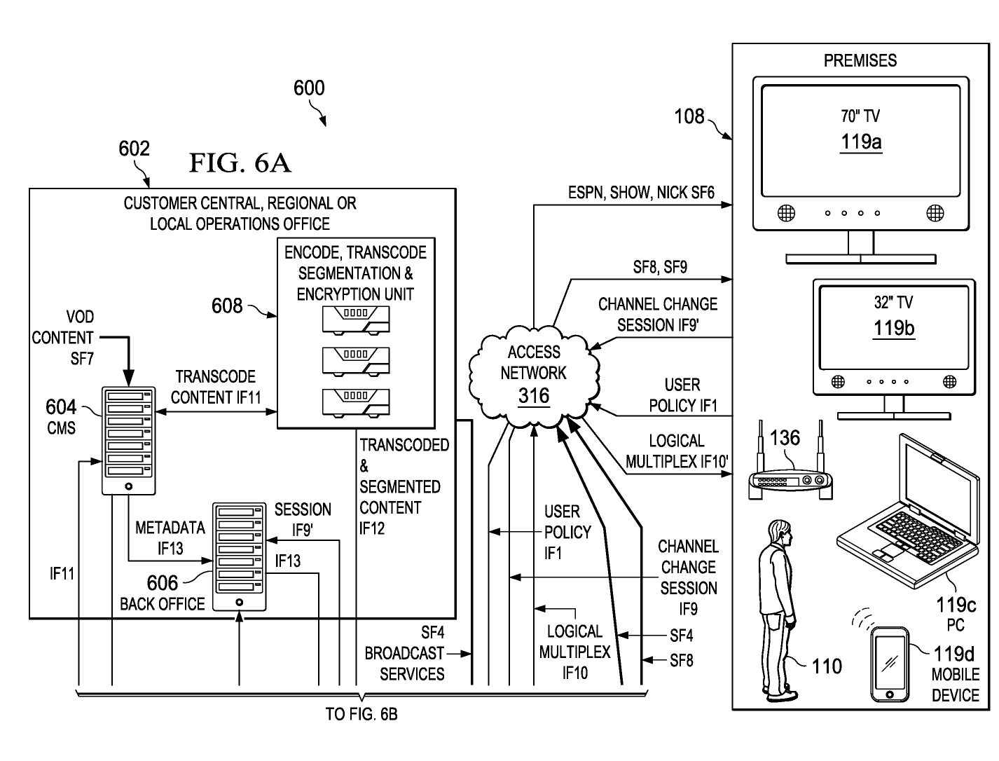

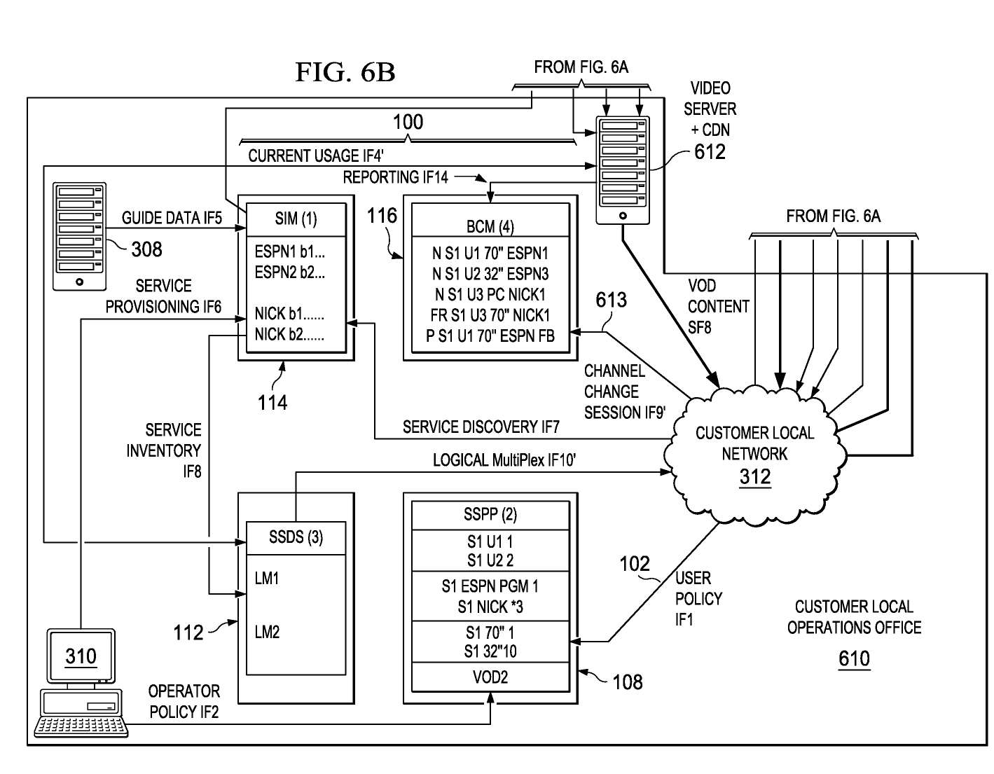

Referring to FIGS. 6A-6B, there is an illustration of an exemplary system 100 incorporated within a IPTV deployment configuration 600 which utilizes broadcast services to logically multiplex broadcast services and video on demand services to the subscriber's premises 108 in accordance with an embodiment of the present invention. The IPTV deployment configuration 600 includes a customer central, regional or local operations office 602 that includes a content management system 604, back office equipment 606, and an encode-transcode-segmentation-encryption unit 608. The IPTV deployment configuration 600 also includes a customer local operations office 610. The customer local operations office 610 incorporates the system 100 which comprises the smart stream delivery server 112, the service inventory manager 114, the bandwidth consumption monitor 116, and the subscriber service profile and policy unit 118. In addition, the customer local operations office 610 incorporates an EPG server 308, a service provider's computer 310, a customer local network 312, and a video server/CDN 612. As shown, the system 100 interfaces with the EPG server 308, the service provider's computer 310, the customer local network 312, and the video-server/CDN 612. The video-server/CDN 612 interfaces with the customer local network 312, the content management system 604, the back office equipment 606, and the encode-transcode-segmentation-encryption unit 608. In addition, the customer local network 312 interfaces with an access network 316 which interfaces with the residential gateway 136 located in the subscriber's premises 108. The residential gateway 136 is connected to the subscriber's devices 119a, 119b, 119c and 119d. The IPTV deployment configuration 600 could include many other well known components but for clarity those components are not described herein.

The aforementioned service flows SF1, SF2, SF4 9 or SF4′), SF5, SF6 and SF9 associated with FIGS. 3-5 apply in this IPTV deployment configuration 600 as well along with the addition of SF7 and SF8 which are as follows:

SF7: The video on demand content 610 is received via a satellite or a network by a receiver (not shown) and is delivered to the content management system 604. The content management system 604 triggers a trans-code of the content into formats determined by the targeted play out devices. The content management system 604 also transforms metadata based on received metadata from the content provider to ensure the metadata content is compatible with the operator's back office equipment 606.
SF8: When the subscriber 110 selects to watch VOD content over the managed network (e.g., non-adaptive streaming content), the streaming is initiated from the video server/CDN 612 and delivered over the customer local network 312 and the access network 316 to the residential gateway 136. Alternatively, the SF8 service flow from the video server/CDN 612 to the customer local network 312 as well as from the customer local network 312 to the access network 316 can combine the adaptive bit rate streaming service flow SF9 as depicted in FIG. 6. In this case, the SF8 and SF9 would be combined from the access network 316 to the residential gateway 136.

The interface definitions IF1, IF2, IF3, IF5, IF6, IF7 and IF8 described above with respect to FIGS. 3-5 apply as well and remain unchanged in the IPTV deployment configuration 600. However, the aforementioned IF4, IF9 and IF 10 are modified to take into account VOD sessions as follows:

IF4′: The IF4′ as described above provides the current as well as the planned bandwidth usage, based off scheduled recordings, into the smart stream delivery server 112. In addition, the IF4′ now also includes the bandwidth consumption based off of the VoD sessions.
IF9′: The channel change session interface IF9′ as described above connects the residential gateway 136 to the bandwidth consumption monitor 116. This allows the bandwidth consumption monitor 116 to accurately have knowledge of each service being delivered to each device 119a, 119b, 119c and 119d. In addition, the IF9′ now also includes an additional video-on-demand interface IF9′ between to the VOD back office equipment 606 and the bandwidth consumption monitor 116 through the customer local network 312 to handle the VOD content session setups.
IF10′: The smart stream delivery server 112 creates the logical multiplex of services 104 which defines all the services to all devices 119a, 119b, 119c and 119d in the premises 108 based on the subscriber policy 102, the service provider policy 134 as well as the operator service provisioning. The logical multiplex of services 104 extends into the residential gateway 136 and allowing the residential gateway 136 to deliver the correct set of services based on the definition calculated by the smart stream delivery server 112. To account for the VOD content, the IF10′ has been added so the calculated logical multiplex of service 104 can include VOD content. The smart stream delivery service 112 to add the VOD asset to the logical multiplex of services 104 uses the same information described above including the subscriber policy 102, the service provider policy 134 etc. . . . as well as the operator service provisioning for the VOD content which can be delivered to the residential gateway 136.

If desired, the IPTV deployment configuration 600 can also be setup to implement an adaptive bit rate streaming functionality. In this case, the logical multiplex interface IF 10′ could be used for manipulating bit rate representations in manifests or for throttling the ABR segment access to enforce control of stream bit rates based off the policies 102 and 134 along with the current and planned bandwidth usage calculated in the smart stream delivery server 112.

The IPTV deployment configuration 600 to account for the VOD sessions also includes new interface definitions for IF11, IF12, IF13 and IF14 as follows:

IF11: Provides the interface from the content management system 604 to the encode-transcode-segmentation-encryption unit 608 so the content management system 604 can request transcoding of content to the formats based on the definitions of the target device 119d (for example) which are stored in the content management system 604. An optional interface IF11 could be added from the service inventory manager 114 to the content management system 604 to automate the acquisition of the definitions of the target device 119d (for example).
IF12: Provides the interface so the encode-transcode-segmentation-encryption unit 608 can write or push the transcoded content to the video server/CDN 612.
IF13: Provides the interface for the back office equipment 606 to request the video server/CDN 612 to begin streaming the VOD content upon the VOD session setup.
IF14: Provides the interface from the video server/CDN 612 to the bandwidth consumption monitor 116 so the VOD streaming session can be taken into account when monitoring the current bandwidth usage to the subscriber's premises 108.

In view of FIGS. 3-6, one can appreciate that there are a wide range of IPTV deployment configurations 300, 400, 500 and 600 etc. . . . that can incorporate and utilize the system 100 in accordance with different embodiments of the present invention. For example, the IPTV deployment configurations 300, 400 and 500 and others can include the use of a statmux 314 or at least the functionality of a statmux 314 to enable what is described herein as “physical multiplex”. In implementing the “physical multiplex”, the statmux 314 acquires the logical multiplex of services 104 from the smart stream delivery server 112 and assembles a MPTS (Multi-Program Transport Stream) which is sent via unicast or multicast from the VHO/CO 306 to the subscriber's residential gateway 136 for all broadcast services being consumed by devices 119a, 119b, 119c and 119d. This configuration utilizes a component within the subscriber's premises 108 such as the residential gateway 136 to perform the corresponding function of removing the physical service from the MPTS and regenerating a SPTS multicast for the particular device 119a, 119b, 119c and 119c which initiated the request 128 (IGMP join) to tune to the particular physical service. An advantage of this configuration is that there is no change needed for the corresponding STB's software. In addition, this approach is independent of the underlying technology used to transport the physical multiplex to the subscriber's premises 108.

In another example, the IPTV deployment configuration 600 and others can utilize what is described herein as “logical multiplex”. As previously described the logical multiplex describes each of the physical services which best reflect the policy defined by the subscriber 110 and possibly by the service operator 125. In addition, when the logical multiplex of services 104 is provided to the subscriber's home 108, the logical multiplex of services 104 will additionally identify the logical and physical service to be used by each device 119a, 119b, 119c and 119d within the subscriber's premises 110. With this information, each device 119a, 119b, 119c and 119c (piece of equipment) can process the logical multiplex of services 104 and based on this information adjust the physical services which it is consuming. By providing the logical multiplex of services 104 straight to the subscriber's premises 108 the solution requires no special equipment within the premises 108 which needs to responsible for de-multiplexing and mapping to physical services. Instead, the logical multiplex of services 104 is made available to all the respective client devices 119a, 119b, 119c and 119d and each of the respective client devices 119a, 119b, 119c and 119d adjusts their consumption based on the logical multiplex of services 104 which was created based at least on their respective subscriber policy 102.

Another IPTV deployment configuration that may be used could utilize a hybrid of the two previous configurations where the logical multiplex of services 104 is communicated to the subscriber's home 108 but a piece of equipment within the premises 108 such as the residential gateway 136 would alter the physical assets being consumed by the devices 119a, 119b, 119c and 119d. Another alternative, would be to have a device with the household such as the residential gateway 136 receive and process the logical multiplex of services 104 and adjust the underlying physical assets being consumed by the devices 119a, 119b, 119c and 119d without the knowledge of the devices 119a, 119b, 119c and 119d.

It should be appreciated that any of the features associated with anyone of the IPTV configurations 300, 400, 500 and 600 can if desired be implemented and used within anyone of the other IPTV configurations 300, 400, 500 and 600 or the system 100 and method 200.

As discussed above with respect to FIG. 1, to implement the bandwidth management-subscriber policy control method 200 a number of elements (logical elements or hardware elements) can be used. Each element may in fact be executed on a single node or by multiple nodes within the service provider's network. The elements described herein include the following:

1) Smart Stream Delivery Server 112 (SSDS 112)

2) Service Inventory Manager 114 (SIM 114)

3) Bandwidth Consumption Monitor 116 (BCM 116)

4) Subscriber Service Profile and Policy Unit 118 (SSPP 118)

### Smart Stream Delivery Server 112 (SSDS 112)

The smart stream delivery server 112 produces for a specific subscriber 110 a logical multiplex (LM) of services 104 which reflect one or more parameters including the subscriber policy 102 and possibly: (1) bandwidth constraints imposed by the at least one network 106 used to deliver the mix of services 104 to the subscriber's premises 108; (2) the totality of services 130 and their respective bit-rates and formats which could be delivered over the at least one network 106 to the subscriber's premises 108; (3) the list 132 of services that are currently being used or schedule to be used by the devices 119a, 119b, 119c and 119d; and (4) the service provider policy 134. The physical services associated with the logical multiplex of services 104 can be provided by equipment in the VHO/CO 306 and consumed by the devices 119a, 119b, 119c and 119d in the subscriber's premises 108.

As each new request 128 is received by the smart stream delivery server 112, the smart stream delivery server 112 pursuant to at least the corresponding subscriber policy 102 will adjust the logical multiplex of services 104 which is to be made available to the subscriber's premises 108 based on information received from the SIM 114, BCM 116 and the SSPP 118. Events within the subscriber's premises 108 which will impact the logical multiplex of services 104 include a channel change, recording initiated, VOD session set-up etc. . . . The event signals or requests 128 are received at the VHO/CO 306 and consumed by the smart stream delivery server 112 and possibly the bandwidth consumption monitor 116 and may result in adjustments to the logical multiplex of services 104 that is assembled based on policy control and possibly other parameters for the subscriber 110.

### Service Inventory Manager 114 (SIM 114)

The service inventory manager 114 exists such that the inventories of all possible services which can be delivered to the subscriber's premises 108 are known. The service inventory manager 114 monitors both logical assets and physical assets for any given service. Attributes of the logical asset would include the asset name which may be the call letters if the service is a regular broadcast service such as “ESPN”. In addition, the service inventory manager 114 may relate the service to information associated with an Electronic Program Guide (EPG) such that further descriptive logical asset information could be used if desired. In the case of VOD assets the logical asset may be the “title” information. The service inventory manager 114 if applicable may also inventory the physical assets to identify numerous physical representations of the same logical piece of content. For example, the content related to the “JAWS” movie may be available in multiple bit-rates and formats which in-effect defines the potential selections of fixed choices.

In the case of broadcast services, the service inventory manager 114 would contain one logical asset per service and one or more physical assets per service. For example, the service provider 125 may receive a transmission (ESPN for example) from the content originator and once received then transcode the feed to any number of bit-rates or formats depending on the variety of services they wish to offer and to effect the ability of adjusting video quality and or video bandwidth to be delivered to the subscriber's premises 108. In addition, the content provider can provide the broadcasts already transcoded into different bit-rates or formats, thus eliminating the need for the service provider 125 to perform the transcoding operation. Similar to a broadcast service, the service provider may receive VOD content in a similar fashion. For instance, the content provider can send VOD content in one format and the service provider 125 can then manipulate the content to any number of bit-rates or formats resulting in numerous physical assets based on the VOD asset received.

The service inventory manager 114 can have an inventory of defined services which are modeled as a logical asset that acts as a container of the associated physical assets along with the required metadata to describe the logical asset as needed by the smart stream delivery server 112 to perform the bandwidth policy management method 200. In particular, this information is provided to and allows the smart stream delivery server 112 to process the bandwidth control to locate other physical manifestations of the same logical service which are available to the subscriber 110. This is possible because the service inventory manager 114 can inventory each physical asset to include all of the associated metadata required for bandwidth control including, for example, bit-rate, resolution, format, container format, transport information.

The service inventory manager 114 can also include an inventory of the physical network on which the logical and physical assets are present. For example, if the service provider 125 has unique channel lineups per some demarcation, the service inventory manager 114 can note where the logical and physical assets exist. An example of a demarcation might include a Video Head End Office (VHO). The service inventory manager 114 can provide this information to the smart stream delivery server 112 such that it knows and can utilize the demarcation of the subscriber 110 along with the totalities of services which are available to the subscriber 110 during the implementation of the policy based method 200. In addition, the service inventor manager 114 can also provide the definitive list of service types for each logical asset that can be utilized by the smart stream delivery server 112 to implement the policy based method 200.

To accomplish all of this, the service inventory manager 114 may incorporate a processor 145, and a memory 147 that stores processor-executable instructions where the processor 145 interfaces with the memory 147 and executes the processor-executable instructions to provide an interface and the service inventory information to the smart stream delivery server 112. In this way, the smart stream delivery server 112 can implement the policy based method 200 while being aware of the services that it can select from while performing the bandwidth control function when an event occurs in the service delivery process including receiving requests 128 associated with a channel change, VOD session initiation, STB initialization, recording scheduling etc. . . .

### Bandwidth Consumption Monitor 116 (BCM 116)

The bandwidth consumption monitor 116 may incorporate a processor 149, and a memory 150 that stores processor-executable instructions where the processor 149 interfaces with the memory 150 and executes the processor-executable instructions to monitor information about the current or planned bandwidth consumption for services provided to the subscriber's premises 108. Basically, the bandwidth consumption monitor 116 tracks, via signaling, all the services and associated bandwidth currently in use by the devices 119a, 119b, 119c and 119d that are under control of the overall bandwidth policy management function. So, the bandwidth consumption monitor 116 is aware of every physical service in use as well as every physical service scheduled (recording) to be used by the various devices 119a, 119b, 119c and 119d at the subscriber's premises 108. If desired, the bandwidth consumption monitor 116 can also maintain a historical record of the services consumed by the subscriber's premises 108 over a period of time such that this historical information can also be provided to the smart stream delivery server 112. The smart stream delivery server 112 can receive and use this information along with the subscriber policy 102 and possibly other parameters to perform bandwidth management to re-arrange physical services to be provided to the subscriber's premises 108.

### Subscriber Service Profile and Policy Unit 118 (SSPP 118)

The subscriber service profile and policy unit 118 may incorporate a processor 153, and a memory 155 that stores processor-executable instructions where the processor 153 interfaces with the memory 155 and executes the processor-executable instructions to capture the service provider profile 134 and associated subscriber policies 102 for each subscriber 110 belonging to the service provider 125. The subscriber service profile and policy unit 118 in addition to storing the basic information related to the subscriber profile 102 for each subscriber 110 can also store more detailed policy assignments which are provided by the subscribers 110 such as the following:

1) Equipment
a. STB & Associated TV
b. Tablet/iPAD
c. PC

2) Users

3) Logical Service
a. Channels from Subscriber EPG Lineup
b. VOD Titles

Service Type
a. Live TV
b. VOD
c. Recordings
   Note: the service provider 125 when generating their service provider policy 134 can provide their policy assignments in the same format and same manner as the subscribers 110.

The subscriber service profile and policy unit 118 can capture a priority assignment for each the four categories of items. For example, the priority assignment can be captured as an integer assignment per item, the larger value indicating the greater importance to the subscriber 110. This information can be presented to the subscriber 110 utilizing a wide-variety of ways. Examples of possible ways could be sliding bars for each item whose calibration is based on the number of physical services available, or checkbox options of high, medium, low. Indeed, there are numerous presentations which can be used so the same information can be made available and the selected policy assignment can also be captured. Using anyone of these schemes, the subscriber 110 may indicate via the policy assignments that bandwidth should be prioritized for “dad”, the user which owns the subscriber account. By prioritizing “dad”, the dad expects that he receives maximum quality and the maximum number of concurrent services possible. Another example might be where the subscriber 110 assigns priority to the 70″ TV 119a in the living room. Another example, would be where the subscriber 110 might be to prioritize “Live TV”. This would prevent a “Recording” of lesser priority (based on service type policy assignment) from interrupting a “Live TV” program if needed. Likewise having equal priority for “Live TV” and “Recording” would allow the service provider portal to allow the subscriber 110 to opt out of one or the other. In any case, from the perspective of the subscriber 110 they are consuming the logical services which are available for which the physical assets may be manipulated.

From the foregoing, the skilled person having the foregoing teaching will readily appreciate that a system 100 has been disclosed which includes the smart stream delivery server 112 that enables many subscribers 110 to configure their own subscriber policy 102 such that they have at least partial control of the resulting services which will be delivered to their respective premises 108. Thus, by allowing the subscribers 110 the ability to define and implement a policy which captures what they consider important, the resulting quality as defined by those subscribers 110 can be improved and provide a significant strategic advantage to the service provider delivering services. This is a marked improvement over the state of the art in which the service provider in-effect defines a fixed set of policies which the subscriber cannot configure so they have no control of the resulting services being delivered to their premises.

In effect, the system 100 described herein provides a means by which what services and the associated quality of those services can be controlled via at least the definition of policies 102 and/or 134 which can be controlled by the subscriber 110 and/or the service provider 125. As such, the service provider 125 can deliver the services to the subscriber 110 which matches the policies 102 and/or 134 rather than provide a one size fits all service delivery arrangement to the subscriber 110. Ultimately, the subscriber 110 will be capable of controlling or at least have some input on how the service should be delivered to their premises 108 resulting in a perceived increase in overall quality by the subscriber 110. Lastly, the system 100 provides for an alternate way of providing recordings for broadcast services which more closely align with the policy 102 and/or 134 desired by the subscriber 110 and/or the service provider 125 and are alterable per subscriber, user, equipment, program and event.

The aforementioned system 100 provides a large number advantages and solves a number of problems associated with existing solutions. Some of these advantages and solved problems are as follows:

1) The service provider 125 can define a policy controlling the usage of bandwidth to the premises 108 for any or all subscribers 110.

2) The service provider 125 can maximize the available bandwidth to subscriber's premises 110 providing a higher quality experience.

3) The service provider 125 can provide more services to the subscriber's premises 108 in a manner which conforms to the policy or policies defined by the service provider 125 or subscriber 110.

4) The subscriber's recordings can have a quality as defined by their policy 102.

5) As each subscriber's premises 108 may have a different bandwidth, the service provider 125 can have policies 134 defined and available for their subscribers 110 which match the bandwidth capacity of a single premise or group of premises. For example, the service provider 125 could define a policy for all subscribers 110 which have 20 Mbs bandwidth and another policy for subscribers 110 which have 7 Mbs of bandwidth.

6) As any element effecting changes to bandwidth may change over time; additional bit-rates for a logical channel, additional bit-rates for VOD or a change in technology, the policy can be implemented without a change to the underlying policy. In other words, the policy 102 or 134 as described herein is not a fixed pairing between a policy selection and a fixed bit-rate or format. For example, if the policy 102 or 134 is captured as a sliding scale of 1 thru 10, there may be less or more than 10 bit-rates or formats. If additional bit-rate choices are introduced to the solution, then the policy 102 or 134 need not be impacted as it may be a relative measurement left to be processed by the SSDS 112. An alternate implementation might fix the sliding scale of the policy 102 or 134 to match the available bit-rates hence if the a new bit-rate is introduced all the policies 102 or 134 would need re-evaluation.

7) The existing solutions also prevent the service provider from providing services to subscribers which do not have a minimum floor of the bandwidth because the service cannot be provided to the household in a manner defined by the subscriber. For example, if a service provider's bandwidth constraint to the home is 6 Mbs and they provide their respective HD service using 6 Mbs and 3 Mbs then the subscriber (or service provider) using the prior art technology cannot configure the policy associated with one subscriber to utilize two 3 Mbs services (enabling two TV's) or to use of one 6 Mbs service (enabling one TV). The system 100 solves this problem.

8) The existing solutions are constrained such that the subscriber cannot define their viewing experience of content beyond that which is defined by the originator of the content or that defined by the existing delivery platforms or service providers. For example, the service provider provides a channel lineup which contains fixed bit-rate channels either in HD or SD. Hence, the subscriber has no ability to control the quality of the HD service provided to their respective household under policy which they define directly or in-directly. The only control the subscriber currently has with the prior art technology is requesting a particular service, getting the service or getting denied access to the service. The system 100 solves this problem.

9) There is no existing solution which provides a means for sharing of a desired viewing experience (the policy) between subscribers allowing for “social networking” and the sharing of a viewing experience. The system 100 enables this particular feature so the subscribers 110 can share their policies 102.

10) In implementing the system 100, the quality of any one particular service delivered to the subscriber's premises 108 can be substantially greater to the subscriber 110 because the quality of any one particular service will be selected based on the policy 102 and the associated bandwidth being consumed by the devices 119a, 119b, 119c and 119d in the premises 108. For example, if the service provider 125 makes HD content available at 5 Mbs maximum because they require that 2 HD signals must be supported by two devices in the home, then if only one device is currently in use, the service provider 125 could be providing the service at 10 Mbs until such time as another device within the subscriber's premises 108 requests an additional service. This can also be controlled by policy 134 established by the service provider 125 and made available to the subscriber 110. The subscriber 110 can associate a policy with a device (i.e. the 70″ 3D HD TV) for example. The subscriber 110 could configure their policy for their service delivery to indicate that when a particular device is in use it in-effect preempts all other devices within the home or by enabling the device the bandwidth and in effect the quality should be distributed equally. Additional policies 102 could be configured based on the service (e.g., ESPN over HGTV), VOD (or a particular VOD title), device, user within the household, recordings.

11) At present, the existing prior art technology may pre-empt other services without the ability of the subscriber to control what service or device or function is pre-empted or de-graded and in what priority. An example, would be AT&T U-verse which if there are 4 recordings scheduled and executing, the subscriber can only watch the desired service if they stop one or more recordings that are in progress. In accordance with the present invention, the subscriber 110 could configure their respective policy 102 such that the recordings still occurs but it is not available until such time as there is adequate bandwidth available to use. Hence, the recordings are not discarded and the subscriber 110 can watch the service when desired.

Finally, one skilled in the art with the teachings herein will appreciate that the aforementioned IPTV service providers and networks are suitable applications for the present invention. It should also be appreciated that the present invention can be applied to any network type or content delivery solution (IPTV or not) that has bandwidth constraints and a control path through which to communicate with the SSDS 112. Plus, it should be appreciated that the SSDS 112 and other components 114, 116 and 118 could be located anywhere within the service provider's network. In fact, the SSDS 112 and other components 114, 116 and 118 can each be a centralized device or a distributed device and located among a plurality of offices/network equipment locations in the service provider's network. Actually, if desired the components 112, 114, 116 and/or 118 with the exception of the stat mux can be located outside the service provider's network.

Although multiple embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the present invention that as has been set forth and defined within the following claims.

1. A smart stream delivery server for assembling a mix of services which are to be delivered over at least one network to a premises of a subscriber, the smart stream delivery server comprising:
a processor; and
a memory that stores processor-executable instructions where the processor interfaces with the memory and executes the processor-executable instructions to enable following:
receive a request for a particular service from a device associated with the subscriber;
assemble the mix of services which are to be delivered over the at least one network to the premises of the subscriber based on the received request, and on at least one or more parameters, where one parameter is a subscriber policy which is provided by the subscriber and comprises:
equipment priorities for a list of devices associated with the subscriber; and
service priorities for a plurality of services which are available for consumption by the devices; and
transmit the assembled mix of services.

2. The smart stream delivery server of claim 1, wherein the assembled mix of services is a logical mix of services which is shared with one or more nodes in the at least one or more networks which then deliver the physical services to the premises of the subscriber.

3. The smart stream delivery server of claim 1, wherein the assembled mix of services is a physical mix of services which are delivered over the at least one network to the premises of the subscriber.

4. The smart stream delivery server of claim 1, wherein the plurality of services includes at least one of linear channels, video on demand, broadcast television, recordings, gaming sessions, and pay per view.

5. The smart stream delivery server of claim 1, wherein another parameter is a totality of services and their respective bit-rates and formats which could be delivered over the at least one network to the premises of the subscriber.

6. The smart stream delivery server of claim 1, wherein another parameter is list of services which are currently being used or scheduled to be used by the devices.

7. The smart stream delivery server of claim 1, wherein another parameter is a service provider policy which is provided by a service provider and prioritizes at least one of a quality and a quantity of the services to be delivered over the at least one network to the premises of the subscriber.

8. The smart stream delivery server of claim 1, wherein the assembled mix of services are determined based on a union of the subscriber policy and the service provider policy, where the service provider policy in case of a conflict would override the subscriber policy.

9. The smart stream delivery server of claim 1, wherein another parameter is a bandwidth constraint imposed by the at least one network used to deliver the mix of services to the premises of the subscriber.

10. A system for assembling a mix of services which are to be delivered over at least one network to a premises of a subscriber, the system comprising:
a smart stream delivery server configured to receive a request for a particular service from a device associated with the subscriber;
a service inventory manager configured to monitor a totality of services including multiple services and their respective bit-rates and formats which can be delivered over the at least one network to the premises of the subscriber;
a bandwidth consumption monitor configured to determine a list of services currently being used or scheduled to be used by the devices;
a subscriber service profile and policy unit configured to store a subscriber policy that is provided by the subscriber and a service provider policy that is provided by a service provider; and
the smart stream delivery server is further configured to interface with the service inventory manager, the bandwidth consumption monitor, and the subscriber service profile and policy unit to assemble the mix of services which are to be delivered over the at least one network to the premises of the subscriber based on the received request and following parameters:
a subscriber policy which is provided by the subscriber and comprises:
equipment priorities for a list of devices associated with the subscriber; and
service priorities for a plurality of services which are available for consumption by the devices;
the totality of services including multiple services and their respective bit-rates and formats which can be delivered over the at least one network to the premises of the subscriber;
the list of services currently being used or scheduled to be used by the devices; and
the service provider policy which prioritizes at least one of a quality and a quantity of the services to be delivered to the premises; and
the smart stream delivery server is further configured to transmit the assembled mix of services.

11. The system of claim 10, wherein the smart stream delivery server is further configured to assemble the mix of services which are to be delivered over the at least one network to the premises of the subscriber within a bandwidth constraint which is imposed by the at least one network used to deliver the mix of services to the premises of the subscriber.

12. A method implemented by a smart stream delivery server for assembling a mix of services which are to be delivered over at least one network to a premises of a subscriber, the method comprising the steps of:
receiving a request for a particular service from a device associated with the subscriber;
assembling the mix of services which are to be delivered over the at least one network to the premises of the subscriber based on the received request and on at least one or more parameters, where one parameter is a subscriber policy which is provided by the subscriber and comprises:
equipment priorities for a list of devices associated with the subscriber; and
service priorities for a plurality of services which are available for consumption by the devices; and
transmitting the assembled mix of services.

13. The method of claim 12, wherein the assembled mix of services is a logical mix of services which is shared with one or more nodes in the at least one or more networks which then deliver the physical services to the premises of the subscriber.

14. The method of claim 12, wherein the assembled mix of services is a physical mix of services which are delivered over the at least one network to the premises of the subscriber.

15. The method of claim 12, wherein the plurality of services includes at least one of linear channels, video on demand, broadcast television, recordings, gaming sessions, pay per view.

16. The method of claim 12, wherein another parameter is a totality of services including multiple services and their respective bit-rates and formats which can be delivered over the at least one network to the premises of the subscriber.

17. The method of claim 12, wherein another parameter is a list of services currently being used or scheduled to be used by the devices.

18. The method of claim 12, wherein another parameter is a service provider policy which is provided by a service provider and prioritizes at least one of a quality and a quantity of the services to be delivered over the at least one network to the premises of the subscriber.

19. The method of claim 18, wherein the assembled mix of services are determined based on a union of the subscriber policy and the service provider policy, where the service provider policy in case of a conflict would override the subscriber policy.

20. The method of claim 12, wherein another parameter is a bandwidth constraint imposed by the at least one network used to deliver the mix of services to the premises of the subscriber.

21. A method for assembling a mix of services which are to be delivered over at least one network to a premises of a subscriber, the method comprising the steps of:
receiving, at a smart stream delivery server, a request for a particular service from a device associated with the subscriber;
monitoring, at a service inventory manager, a totality of services including multiple services and their respective bit-rates and formats which can be delivered over the at least one network to the premises of the subscriber;
determining, at a bandwidth consumption monitor, a list of services currently being used or scheduled to be used by the devices;
storing, at a subscriber service profile and policy unit, a subscriber policy that is provided by the subscriber and a service provider policy that is provided by a service provider;
assembling, at the smart stream delivery server, the mix of services which are to be delivered over the at least one network to the premises of the subscriber based on the received request and on following parameters:
the subscriber policy which is provided by the subscriber and comprises:
equipment priorities for a list of devices which consume the services; and
service priorities for a plurality of services which are available for consumption by the devices;
the totality of services including multiple services and their respective bit-rates and formats which can be delivered over the at least one network to the premises of the subscriber;
the list of services currently being used or scheduled to be used by the devices; and
the service provider policy which prioritizes at least one of a quality and a quantity of the services to be delivered to the premises; and
transmitting, from the smart stream delivery server, the assembled mix of services.

22. The method of claim 21, wherein the assembling step further comprises assembling the mix of services which are to be delivered over the at least one network to the premises of the subscriber within a bandwidth constraint imposed by the at least one network used to deliver the mix of services to the premises of the subscriber.
